(19) United States
(12) Patent Application Publication
(10) Pub. No.: US 2009/0297661 A1
(43) Pub. Date: Dec. 3, 2009

(54) Methods For Flavor Enhancement

(75) Inventor: Isaac Ashie, Raleigh, NC (US)

Correspondence Address: NOVOZYMES NORTH AMERICA, INC., 500 FIFTH AVENUE, SUITE 1600, NEW YORK, NY, 10110, US

(73) Assignee: Novozymes North America,Inc., Franklinton, NC (US)

(21) Appl. No.: 12/537,322

(22) Filed: Aug. 7, 2009

Related U.S. Application Data
(63) Continuation of application No. 11/333,587, filed on Jan. 17, 2006.
(60) Provisional application No. 60/644,851, filed on Jan. 18, 2005.

(51) Int. Cl. A23J 3/34; A23L 2/56; A23L 1/20; A23L 1/318

(52) U.S. Cl. 426/42; 426/7; 426/46; 426/56

(57) ABSTRACT

The present invention is directed to methods of generating Umami flavor in-situ in food and beverage compositions by treating food or beverage compositions with an enzyme composition having glutamate releasing activity. The glutamate residues, free form, or C or N terminal short peptides produce Umami taste enhancement in the treated food or beverage. The present invention is also directed to methods of generating Umami flavor in-situ in food and beverage compositions by treating food or beverage compositions with an enzyme composition having aspartate releasing activity. The aspartate residues, free form, or C or N terminal short peptides produce Umami taste enhancement in the treated food or beverage.

### CROSS-REFERENCE TO RELATED APPLICATIONS

This application is a continuation of U.S. application Ser. No. 11/333,587 filed on Jan. 17, 2006 which claims priority or the benefit under 35 U.S.C. 119 of U.S. provisional application No. 60/644,851 filed Jan. 18, 2005, the contents of which are fully incorporated herein by reference.

### FIELD OF THE INVENTION

The present invention relates to methods for preparing a flavor enhancer and to food and beverage compositions comprising the flavor enhancer.

### BACKGROUND

Flavor traditionally entails four main taste components: sourness, bitterness, saltiness and sweetness. Umami, or “deliciousness” in Japanese, is now considered to be a fifth taste component. Umami is the taste resulting from the natural occurrence or intentional addition of compounds, such as, monosodium glutamate (MSG), 5′-nucleotides, such as, 5′inosinate (IMP) and 5′-guanylate (GMP). Such compounds are especially interesting in that they have the ability to modify taste, even though they do not possess characteristic flavors of their own, especially at the low concentrations at which they affect food flavor. Glutamate is the one that has attracted the most attention due to its association with MSG.

A number of approaches to enhancing flavor have been proposed in the art. For example, the incorporation of yeast extracts or hydrolyzed proteins from both animal and plant sources has resulted in the flavor intensification/modification of various foods. This approach has specific application for many foods and beverages. For example, the addition of yeast extracts and hydrolyzed proteins has resulted in improved taste in, and an increased acceptance of, low-fat meat products, which would otherwise lack characteristic meat flavor. See Maga, “Umami flavor of Meat”, Flavour of Meat, Meat Prods and Seafoods, 197-216 (1983).

Enzymatic treatment of food and beverage proteins, such as, protease hydrolysis of soy protein, has been used to obtain flavor enhancement. U.S. Pat. Nos. 6,007,851 and 6,190,709, for example, describe the preparation of a flavor enhancer in which soy protein is enzymatically hydrolyzed by mixtures of endo-proteases and exo-peptidases to achieve a flavor enhancer which is low in monosodium glutamate. The flavor enhancer is stated to be useful for meat, vegetables and dairy.

U.S. Pat. No. 5,077,062 describes a flavor enhancer which is prepared by hydrolyzing soy material using a protease to obtain a low sodium, low monosodium glutamate soy hydrolysate.

U.S. Pat. No. 6,465,209 describes preparation of a protein hydrolysate, which can be used as a flavor enhancer, by treating proteinaceous material with one or more aminopeptidases having glycine releasing properties and one or more additional proteases.

There is a need in the art for improved flavor enhancement methods. There is also a need in the art for improved flavor enhancement methods which reduce MSG and other food additives, yet maintain a rich food flavor.

### SUMMARY OF THE INVENTION

The present invention is directed to methods of generating Umami flavor in-situ in food and beverage compositions by treating food or beverage compositions with an enzyme composition having glutamate-specific and/or glutamate releasing activity. The generation of the glutamate residues in situ produces Umami flavor and enhances the flavor of the food or beverage composition. The present invention can accordingly be used to significantly reduce or eliminate non-natural food additives, such as, MSG and other food additives, such as, salt.

The present invention is directed to methods of generating Umami flavor in-situ in food and beverage compositions by treating food or beverage compositions with an enzyme composition having aspartate-specific and/or aspartate releasing activity. The generation of the aspartate residues in situ produces Umami flavor and enhances the flavor of the food or beverage composition.

The present invention is directed to methods of generating Umami flavor in-situ in food and beverage compositions by treating food or beverage compositions with an enzyme composition having glutamate-specific or glutamate releasing activity and aspartate-specific or aspartate releasing activity. The generation of the glutamate and aspartate residues in situ produces Umami flavor and enhances the flavor of the food or beverage composition.

In a preferred embodiment of the present invention, protease compositions comprising one or more proteases are used to hydrolyze various proteins present in food or beverage compositions to generate glutamate and/or aspartate residues in situ. One preferred embodiment of the present invention comprises treating a food or beverage composition with at least one glutamate-specific endo-protease, wherein the glutamate-specific endo-protease hydrolyzes the protein to generate at least one N-terminal and/or C-terminal glutamate containing protein. Unless the treatment with the glutamate specific endo-protease obtains sufficient Umami taste by generating free form glutamate residue or short chain N or C terminal glutamate containing peptides, the glutamate-specific endo-protease treatment is preferably used in combination with at least one amino-peptidase and/or carboxy-peptidase, which release the N-terminal and/or C-terminal glutamate residues from the N-terminal and/or C-terminal glutamate containing protein produced with the glutamate-specific endo-protease. The glutamate-specific endo-protease may also be used in combination with other protease or peptidase to produce shorter chain glutamate containing peptides, such as, dipeptides or tripeptides.

Another preferred embodiment of the present invention comprises treating a food or beverage composition with an aspartate specific endo-protease, wherein the aspartate specific endo-protease hydrolyzes the protein to generate at least one N-terminal and/or C-terminal aspartate containing protein. Unless the treatment with the aspartate specific endo-protease obtains sufficient Umami taste by generating free form aspartate residue or short chain N or C terminal aspartate containing peptides, the aspartate specific endo-protease treatment is preferably used in combination with at least one amino-peptidase and/or carboxy-peptidase, which release the N-terminal and/or C-terminal aspartate residues from the N-terminal and/or C-terminal aspartate containing protein produced with the aspartate specific endo-protease. The aspartate specific endo-protease may also be used in combination with other protease or peptidase to produce shorter chain aspartate containing peptides, such as, dipeptides or tripeptides.

### DETAILED DESCRIPTION

The present invention relates to the use of glutamate releasing enzymes, preferably a glutamate releasing protease composition, to generate free form glutamate resides and/or short chain C or N terminal glutamate containing peptides in situ in food and/or beverage compositions in order to generate Umami flavor enhancement.

A “free form” glutamate residue means a single glutamate residue. Although free form glutamate residues are preferred to obtain the strongest Umami flavor enhancement in the food or beverage composition, the present invention may also be used to generate short chain, C or N terminal glutamate containing peptides. A short chain, C or N terminal glutamate containing peptide includes peptides which are dipeptides (Glu-X or X-Glu) or tripeptides (Glu-X-X or X-X-Glu). Peptides which are significantly longer will generate less noticeable Umami flavor or no detectable Umami flavor.

In a preferred embodiment, the Umami flavor enhancement is generated by treating the food or beverage composition with a glutamate releasing protease composition comprising a glutamate specific endo-protease. As used herein, a “glutamate specific endo-protease” is a protease which breaks down proteins to peptides by specifically cleaving peptide bonds involving glutamate residues. Such enzymes include glutamyl endoprotease having the Enzyme Classification Number E.C. 3.4.21.19 of the International Union of Biochemistry and Molecular Biology. A glutamate specific endo-protease may be obtained from any suitable source, such as, a micro-organism, e.g., a bacteria, fungi or yeast. The glutamate specific endo-protease may preferably be obtained from a Bacillus strain, such as, Bacillus licheniformnis and Bacillus subtilis, a Staphylococcus strain, such as, Staphylococcus aureus, a Streptomyces strain, such as Streptomyces thermovulgaris and Streptomyces griseus or an Actinomyces strain. A preferred glutamate specific endo-protease is the glutamate/aspartate specific protease (SP446), which may be obtained as described in WO 91/13554.

The glutamate specific endo-protease treatment is preferably used in combination with another protease or peptidase treatment of the food or beverage composition to obtain free form glutamate resides or short chain C or N terminal glutamate containing peptides in situ. Preferably, the other protease or peptidase is an exo-peptidase. As used herein an “exo-peptidase” is a peptidase which hydrolyzes proteins or peptides by cleaving (i) individual amino acids, (ii) dipeptides or (iii) tripeptides from the N-terminal or C-terminal of a protein or peptide. The exo-peptidase may be used to remove individual glutamate residues or N or C terminal glutamate containing dipeptides or tripeptides from peptides generated following with glutamate specific endo-protease treatment.

It is preferred that the glutamate specific endo-protease is purified and substantially free of other protease components, such as, at least 50% pure, at least 60% pure, at least 70% pure, at least 80% pure, at least 90% pure, at least 91% pure, at least 92% pure, at least 93% pure, at least 94% pure, at least 95% pure, at least 96% pure, at least 97% pure, at least 98% pure, at least 99% pure, at least 99.1% pure, at least 99.2% pure, at least 99.3% pure, at least 99.4% pure, at least 99.5% pure, at least 99.6% pure, at least 99.7% pure, at least 99.8% pure, at least 99.9% pure, at least 100% pure. The use of purified glutamate specific endo protease can be used to enhance the production of free form glutamate residues.

Exo-peptidases include both amino-peptidases and carboxy-peptidases. An “amino peptidase” is an exo-peptidase which catalyzes the removal of one or more amino acid residues from the N-terminus of peptides, polypeptides and proteins. Such enzymes include the enzymes classified under the Enzyme Classification Number E.C. 3.4.11 of the International Union of Biochemistry and Molecular Biology. Amino-peptidases are known in the art and include, for example, the amino-peptidases disclosed in WO 96/28542, JP-7-5034631 JP-7-4021798 Nakada et al., 1972, Agricultural and Biological Chemistry 37: 757-765; Nakada et al., 1972, Agricultural and Biological Chemistry 37: 767-774; Nakada et al., 1972, Agricultural and Biological Chemistry 37: 775-782; Kwon et al., 1996, Journal of Industrial Microbiology 17: 30-35), WO 97/04108, Chang and Smith (1989, Journal of Biological Chemistry 264: 6979-6983) Chang et al. (1992, Journal of Biological Chemistry 267: 8007-8011), Beauvais et al. (1997, Journal of Biological Chemistry 272: 6238-6244), Tachi et al. (1992, Phytochemistry 31: 3707-3709), U.S. Pat. No. 6,800,467, and U.S. Pat. No. 6,664,092.

A preferred amino peptidase is a glutamyl aminopeptidase (E.C. 3.4.11.7) which releases N-terminal glutamate residues from peptides.

As used herein, a “carboxypeptidase” is an exo-peptidase which catalyzes the removal of one or more amino acids residues from the C-terminus of peptides, polypeptides and proteins. Examples of carboxypeptidase are a glutamate carboxypeptidase (E.C. 3.4.17.11), aspartate carboxypeptidase, proline carboxypeptidase (E.C.3.4.16.2), carboxypeptidase A (E.C.3.4.17.1), carboxypeptidase B (EC 3.4.17.2), carboxypeptidase C (EC 3.4.16.5), carboxypeptidase D (EC 3.4.16.6), a lysine (arginine) carboxypeptidase (E.C 3.4.17.3), a glycine carboxypeptidase (E.C 3.4.16.6), an alanine carboxypeptidase (EC 3.4.17.6), a peptidyl-dipeptidase A (E.C 3.4.15.1) or a peptidyl-dipeptidase (E.C. 3.4.15.5).

A preferred carboxy peptidase is a glutamate carboxypeptidase (E.C. 3.4.17.11 and E.C.3.4.17.21) which releases C-terminal glutamate residues from peptides.

The glutamate specific endo-protease may also be used in combination with a non-glutamate specific endo-protease which can be used to shorten the N or C terminal glutamate containing protein. For example, the non-glutamate specific endo-protease or endo-peptidase will shorten the N or C terminal peptide generated from treating the food or beverage composition with a glutamate specific endo-protease, preferably, to generate a free form glutamate residue or a short chain, N or C terminal glutamate containing peptide of a length sufficient to generate Umami taste, e.g., a dipeptide or tripeptide.

In a preferred embodiment, the glutamate specific endo-protease is used in combination with the protease FLAVOURZYME (Novozymes A/S).

The present invention also relates to the use of aspartate releasing enzymes, preferably an aspartate releasing protease composition, to generate free form aspartate resides and/or short chain C or N terminal aspartate containing peptides in situ in food and/or beverage compositions in order to generate Umami flavor enhancement.

A “free form” aspartate residue means a single aspartate residue. Although free form aspartate residues are preferred to obtain the strongest Umami flavor enhancement in the food or beverage composition, the present invention may also be used to generate short chain, C or N terminal aspartate containing peptides. A short chain, C or N terminal aspartate containing peptide includes peptides which are dipeptides (Asp-X or X-Asp) or tripeptides (Asp-X-X or X-X-Asp). Peptides which are significantly longer will generate less noticeable Umami flavor or no detectable Umami flavor.

In a preferred embodiment, the Umami flavor enhancement is generated by treating the food or beverage composition with an aspartate releasing protease composition comprising an aspartate specific endo-protease. As used herein, an “aspartate specific endo-protease” is a protease which breaks down proteins to peptides by specifically cleaving peptide bonds involving aspartate residues. Such enzymes include the endoprotease having the Enzyme Classification Number E.C. 3.4.21.19 of the International Union of Biochemistry and Molecular Biology. An aspartate specific endo-protease may be obtained from any suitable source, such as, a micro-organism, e.g., a bacteria, fungi or yeast. Because of the similar structure between glutamate and aspartate, glutamate specific endo-proteases may cleave aspartate residues and aspartate specific endo-proteases may also cleave glutamate residues. A preferred aspartate specific endo-protease is the glutamate/aspartate specific protease (SP446), which may be obtained as described in WO 91/13554.

It is preferred that the aspartate specific endo-protease is purified and substantially free of other protease components, such as, at least 50% pure, at least 60% pure, at least 70% pure, at least 80% pure, at least 90% pure, at least 91% pure, at least 92% pure, at least 93% pure, at least 94% pure, at least 95% pure, at least 96% pure, at least 97% pure, at least 98% pure, at least 99% pure, at least 99.1% pure, at least 99.2% pure, at least 99.3% pure, at least 99.4% pure, at least 99.5% pure, at least 99.6% pure, at least 99.7% pure, at least 99.8% pure, at least 99.9% pure, at least 100% pure. The use of purified aspartate specific endo protease can be used to enhance the production of free form aspartate residues.

The aspartate specific endo-protease treatment is preferably used in combination with another protease or peptidase treatment of the food or beverage composition to obtain free form aspartate resides or short chain C or N terminal aspartate containing peptides in situ. Preferably, the other protease or peptidase is an exo-peptidase. The exo-peptidase may be used to remove individual aspartate residues or N or C terminal aspartate containing dipeptides or tripeptides from peptides generated following with aspartate specific endo-protease treatment.

The aspartate specific endo-protease may also be used in combination with a non-aspartate specific endo-protease which can be used to shorten the N or C terminal aspartate containing protein. For example, the non-aspartate specific endo-protease or endo-peptidase will shorten the N or C terminal peptide generated from treating the food or beverage composition with an aspartate specific endo-protease, preferably, to generate a free form aspartate residue or a short chain, N or C terminal aspartate containing peptide of a length sufficient to generate Umami taste, e.g., a dipeptide or tripeptide.

Glutamate-containing and aspartate-containing proteins are found in most food and beverage compositions. Food proteins which may be treated as described herein are animal (beef, pork, poultry, and dairy proteins) and vegetable proteins (wheat, soy, maize, gluten, casein). Accordingly, as used herein, a “food composition” encompasses, without limitation, beef, pork, lamb, chicken, seafood (e.g., fish, shrimp, scallops), processed meat, meat emulsions, soups, sauces, seasonings, dressings, vegetables (such as, e.g., wheat, pea and soy, including soy food, soy flour, soy protein, soy isolated, soy bean flakes, soy bean meal, soy bean grits). A food composition also encompasses a composition of food protein(s) comprising a protein which are obtained from a food, which may then be treated with the glutamate specific endo-protease and/or aspartate specific endo-protease, preferably in combination with other proteases or peptidases as described herein, and added back to the food from which it was obtained or added to another food or beverage so as to provide a Umami taste.

As used herein, a “beverage composition” encompasses, without limitation, milk and dairy beverages, soy beverage, sports drinks and protein enriched drinks, and powdered beverage compositions. A beverage composition also encompasses a composition of beverage protein(s) which are treated with the glutamate specific endo-protease and/or aspartate specific endo-protease, preferably in combination with other peptidases and proteases, as described herein, and added back to the beverage from which it was obtained or added to another food or beverage so as to provide Umami taste.

As used herein, “in situ” generation of Umami taste means generation of the taste directly in the food or beverage composition.

The enzymatic treatment(s) may take place at any convenient temperature at which the enzymes do not become inactivated, preferably, in the range from about 20° C. to 70° C. In accordance with standard practice the enzymes may be inactivated after use by increasing the temperature of the incubation mixture to a temperature where the enzymes become inactivated (e.g., above 80° C.) or by decreasing the pH of the incubation mixture to a point where the enzymes become inactivated (e.g. below pH 4.0)

It will be understood that each of the reaction conditions (such as, e.g., concentration of protease or peptidase, ratio of protease to food/beverage, mode of contacting, pH, temperature, and time) may be varied, depending upon the source of food/beverage and/or enzyme and the degree of hydrolysis that is desired. It will further be understood that optimization of the reaction conditions may be achieved using routine experimentation by establishing a matrix of conditions and testing different points in the matrix. The protease and/or peptidase compositions may be applied in any suitable form, such as, in liquid or powder form, as are well known in the art.

The protease and/or peptidase treatment described herein is preferably carried out at suitable food or beverage processing temperatures and pH conditions as appropriate for the food or beverage and for the protease and peptidase. The protease and peptidase treatment is carried out for a period of time sufficient to hydrolyze the peptide bonds of the food or beverage so as to generate the N and/or C terminal glutamate residues and free form glutamate residues and/or short chain N and/or C terminal glutamate containing peptides and/or the N and/or C terminal aspartate residues and free form aspartate residues and/or short chain N and/or C terminal aspartate containing peptides.

### EXAMPLES

8% soy protein solution was prepared and 800 g batches were pre-heated in reaction vessels to 55° C. To each 800 g batch, 0.4 AU of either a broad-specificity protease composition (ALCALASE) or a glutamate-specific endoprotease (Sp446 available from Novozymes) or their combination with 1000 LAPU of FLAVOURZYME (an exo-peptidase and having some endoprotease activity, available from Novozymes A/S). The protein solution was hydrolyzed for 4 hrs with gentle agitation. The reaction was terminated by transferring reaction vessels to a pre-heated bath at 85° C. for 10 minutes. After cooling down the products, they were centrifuged and the supernatant used for protein and amino acid analysis.

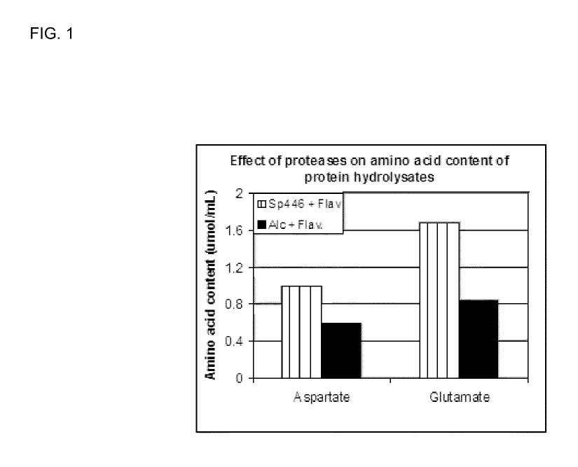

The test results in FIG. 1 show that the glutamate and aspartate content is higher in the hydrolysates produced by combination of the N and/or C terminal glutamate residues and free form glutamate residues and/or short chain N and/or C terminal glutamate containing peptides than the corresponding broad specificity protease and exo-peptidase. The higher content of these amino acids therefore increases the intensity of savory (Umami) flavor.

1. A method of producing Umami flavor in situ in a food or beverage composition comprising treating a food or beverage composition with a glutamate releasing protease composition to generate free form glutamate residue or a short chain, N or C terminal glutamate containing peptide, and an aminopeptidase and/or carboxy-peptidase.

2. The method of claim 1, wherein the glutamate releasing protease composition comprises a glutamate specific endo-protease.

3. (canceled)

4. The method of claim 1, wherein the glutamate releasing protease composition comprises a glutamate specific endo protease and another endo-protease and/or endo-peptidase.

5. The method of claim 1, wherein the glutamate releasing protease composition comprises a glutamate specific endo-protease, an amino and/or carboxypeptidase, and another endo-protease or endo-peptidase.

6. The method of claim 1, wherein the glutamate releasing composition comprises a glutamate specific endo-protease and carboxypeptidase.

7. The method of claim 1, wherein the glutamate releasing composition comprises a glutamate specific endo-protease and an aminopeptidase.

8. The method of claim 1, wherein the method generates free form glutamate residues.

9. The method of claim 1, wherein the method generates short chain, N or C terminal glutamate containing peptide.

10. The method of claim 1, wherein the food or beverage composition is beef, pork, poultry, seafood, vegetable or dairy composition.

11. The method of claim 1, wherein the food or beverage composition is a soy composition.

12. A method of producing Umami flavor in situ in a food or beverage composition comprising treating a food or beverage composition with an aspartate releasing protease composition to generate free form aspartate residue or a short chain, N or C terminal aspartate containing peptide, and an aminopeptidase and/or carboxy-peptidase.

13. The method of claim 12, wherein the aspartate releasing protease composition comprises an aspartate specific endo-protease.

14. (canceled)

15. The method of claim 12, wherein the aspartate releasing protease composition comprises an aspartate specific endo protease and another endo-protease and/or endo-peptidase.

16. The method of claim 12, wherein the aspartate releasing protease composition comprises an aspartate specific endo-protease, an aminopeptidase and/or carboxypeptidase, and another endo-protease or endo-peptidase.

17. The method of claim 12, wherein the aspartate releasing composition comprises an aspartate specific endo-protease and a carboxypeptidase.

18. The method of claim 12, wherein the aspartate releasing composition comprises an aspartate specific endo-protease and an aminopeptidase.

19. The method of claim 12, wherein the aspartate releasing composition comprises an aspartate specific endo-protease, a carboxypeptidase and an aminopeptidase.

20. The method of claim 12, wherein the method generates free form aspartate residues.

21. The method of claim 12, wherein the method generates short chain, N or C terminal aspartate containing peptide.

22. The method of claim 12, wherein the food or beverage composition is beef, pork, poultry, seafood, vegetable or dairy composition.

23. The method of claim 12, wherein the food or beverage composition is a soy composition.

24. (canceled)
